(19) United States
(12) Patent Application Publication
(10) Pub. No.: US 2015/0266757 A1
(43) Pub. Date: Sep. 24, 2015

(54) GREASE INTERCEPTOR

(71) Applicant: TG DIGESTERS CANADA INC., Toronto (CA)

(72) Inventors: Stephanie LOEB, New Haven, CT (US); Matt SHALHOUB, Tecumseh (CA)

(21) Appl. No.: 14/667,045

(22) Filed: Mar. 24, 2015

Related U.S. Application Data
(60) Provisional application No. 61/969,484, filed on Mar. 24, 2014.

(51) Int. Cl. C02F 1/72; C02F 1/78

(52) U.S. Cl. CPC C02F 1/72; C02F 1/722; C02F 1/78; C02F 2101/32

(57) ABSTRACT

There is provided a process for treating an aqueous liquid mixture comprising: effecting separation, based on density differences, from an aqueous liquid mixture, of at least a fraction of organic liquid material of the aqueous liquid material such that an organic liquid material-enriched phase becomes disposed above an organic liquid material-depleted phase; and contacting the organic liquid material-enriched phase with reagent material within a reaction zone and in sufficient proximity to a solid catalyst material such that a reactive process, effected by the contacting, and catalyzed by the solid catalyst material, effects production of reaction products. There is also provided an apparatus for implementing the above-described process.

### FIELD

The present disclosure relates to grease interceptors and methods for removing fats, oils and greases (“FOG”) from liquid waste material.

### BACKGROUND

Existing grease interceptor technology does not easily lend itself for use in spatially-challenged environments to treat FOG-containing liquid waste material so as to enable discharge of the treated material to municipal sewers.

### SUMMARY

There is provided an apparatus comprising: an inlet for receiving flow of an aqueous liquid mixture including water and an organic liquid material; a treatment compartment including a treatment compartment space disposed in fluid communication with the inlet for receiving the aqueous liquid mixture, the treatment compartment space being configured such that, when the aqueous liquid mixture is received by the treatment compartment space, separation of at least a fraction of the organic liquid material from the aqueous liquid mixture, based on differences in density, is effected within the treatment compartment space such that an organic liquid material-enriched liquid phase becomes disposed above an organic liquid material-depleted liquid phase within the treatment compartment space; at least one solid catalyst material support, wherein each one of the at least one solid catalyst material support is, independently, configured for supporting solid catalyst material within a reaction zone of the treatment compartment space; at least one reagent supply inlet configured for supplying reagent material to the reaction zone such that contacting of the reagent material and the separated organic material within the reaction zone effects a reactive process, catalyzed by the solid catalyst material, such that a reaction product is produced; and an outlet for discharging the organic liquid material-depleted liquid phase from the apparatus.

There is also provided a process for treating an aqueous liquid mixture comprising: effecting separation, based on density differences, from an aqueous liquid mixture, of at least a fraction of organic liquid material of the aqueous liquid material such that an organic liquid material-enriched phase becomes disposed above an organic liquid material-depleted phase; and contacting the organic liquid material-enriched phase with reagent material within a reaction zone and in sufficient proximity to a solid catalyst material such that a reactive process, effected by the contacting, and catalyzed by the solid catalyst material, effects production of reaction products.

### BRIEF DESCRIPTION OF DRAWINGS

The preferred embodiments will now be described with the following accompanying drawings, in which:

FIG. 1 is a top perspective view of an embodiment of an apparatus of the present disclosure;

FIG. 2 is a schematic sectional side elevation view of an embodiment of an apparatus of the present disclosure, also illustrating implementation of an embodiment of a process of the present disclosure;

FIG. 3 is a schematic sectional side elevation view of another embodiment of an apparatus of the present disclosure, having a plurality of reagent delivery apparatuses with solid catalyst particulate material disposed within a permeable container;

FIG. 4 is a top perspective view of a lid of the embodiment of an apparatus of the present disclosure, having, similar to FIG. 3, a plurality of reagent delivery apparatuses with solid catalyst particulate material disposed within a permeable container;

FIG. 5 is a side sectional elevation of a portion of the embodiment of an apparatus illustrated in FIG. 4, showing a reagent supply inlet, a reagent distribution manifold, and a reagent delivery apparatus; and

FIG. 6 is a schematic illustration of the implementation of an embodiment of a process of the present disclosure within the apparatus illustrated in FIG. 2.

### DETAILED DESCRIPTION

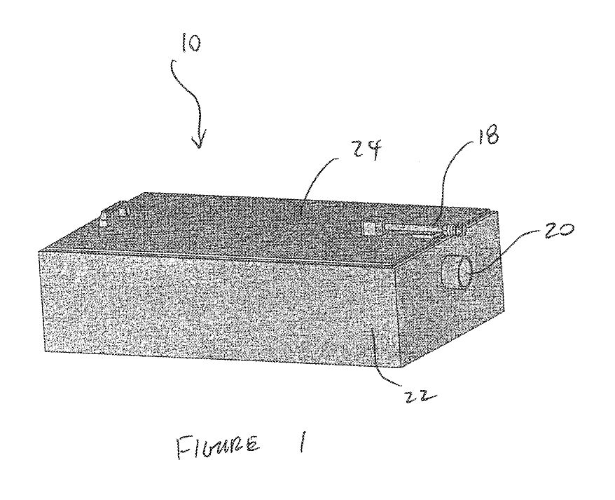

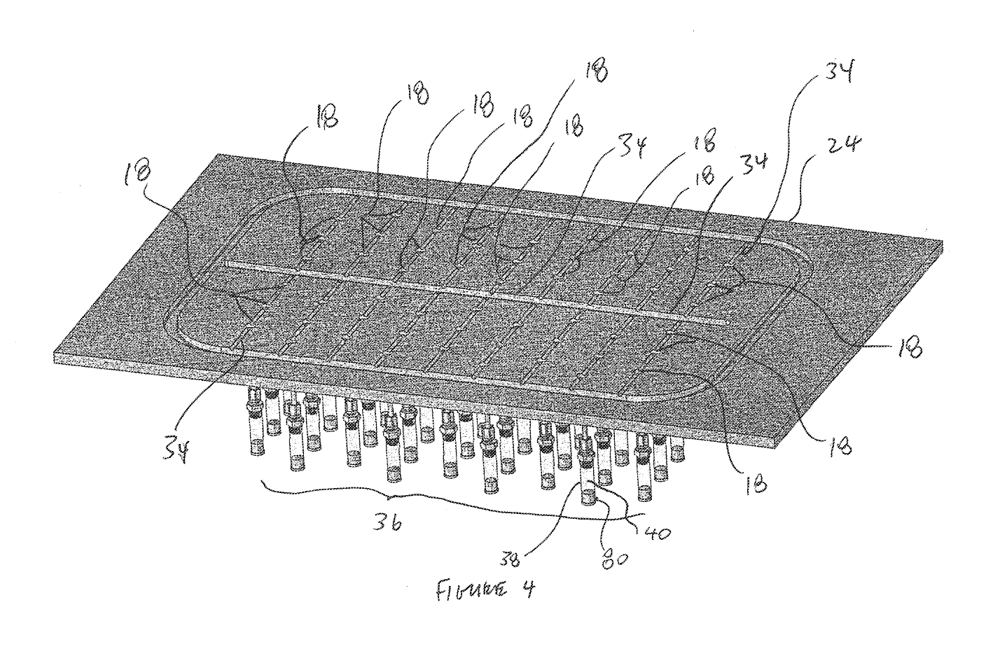

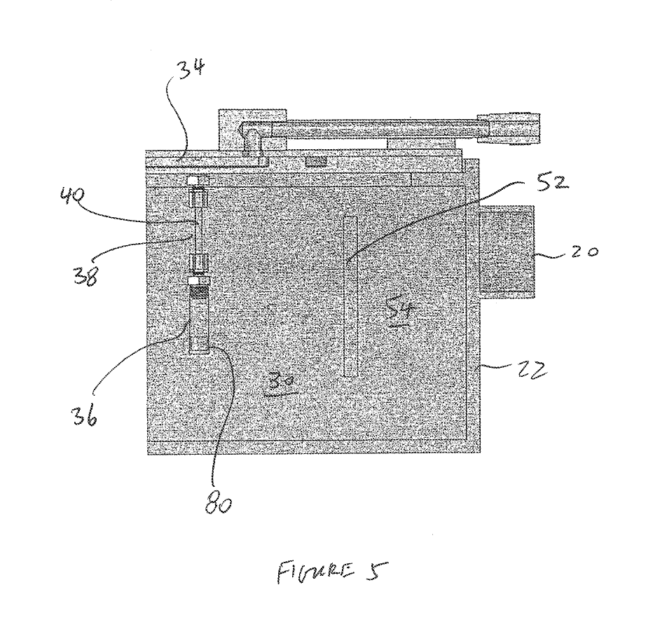

Referring to FIGS. 1 to 5, there is provided a material treatment apparatus 10. In some operational implementations, the apparatus 10 is configured for use in treating aqueous liquid material that includes organic liquid material, such as, for example, liquid waste material, such as, for example, liquid waste material that includes at least one, or any combination of, fats, oils, and greases. The apparatus 10 may be constructed of construction grade plastics, such as polyvinyl chloride, polyethylene, acrylic. The apparatus may also be constructed of stainless steel or aluminum.

In some embodiments, for example, the liquid waste material is derived from food waste, such as from a restaurant. In some embodiments, for example, the liquid waste material includes at least 5 mg/L of fats, oils, and greases. In some embodiments, for example, the liquid waste material includes solids.

The apparatus 10 includes a liquid mixture inlet 12, a treatment compartment 14, at least one catalyst material support 16, at least one reagent supply inlet 18, and an outlet 20.

In some embodiments, for example, the apparatus 10 includes a container 22 and a lid 24. The container defines 22 at least the treatment compartment 14. The lid 24 is positionable relative to the container 22 for at least partially occluding (such as, for example, by covering) at least the treatment compartment 14. In some of these embodiments, for example, the occluding (e.g. covering) is complete or substantially complete. In those embodiments where the apparatus 10 includes inlet and/or outlet compartments 26, 28 (see below), the lid 24 is positionable relative to the container 22 for at least partially occluding (such as, for example, by covering) at least these compartments 26, 28 as well, and in some of these embodiment, for example, the occluding (e.g. covering) is complete or substantially complete. In some embodiments, for example, the lid 24 is hingedly coupled to the container.

The liquid mixture inlet 12 is for receiving flow of an aqueous liquid mixture including water and an organic liquid material.

The treatment compartment 14 including a treatment compartment space 30. The treatment compartment space 30 is disposed in fluid communication with the inlet 12 for receiving the aqueous liquid mixture. The treatment compartment space 30 is configured such that, when the aqueous liquid mixture is received by the treatment compartment space 30, separation of at least a fraction of the organic liquid material from the aqueous liquid mixture, based on differences in density, is effected within the treatment compartment space 30 such that an organic liquid material-enriched liquid phase becomes disposed above an organic liquid material-depleted liquid phase within the treatment compartment space 30. In some embodiments, for example, the separation of at least a fraction of the organic liquid material from the aqueous liquid mixture is effected in response to buoyancy forces.

With respect to the at least one solid catalyst material support 16, the at least one solid catalyst material support 16 is configured for supporting solid catalyst material within a reaction zone 32 of the treatment compartment space 30.

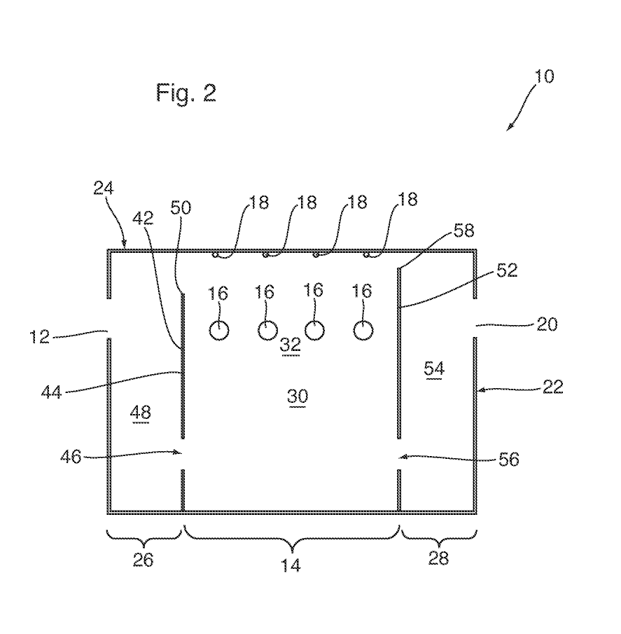

Referring to FIG. 2, in some embodiments, for example, the at least one solid catalyst material support 16 includes a substrate, coupled to the container, to which the solid catalyst material is to be adhered. In some of these embodiments, for example, the adherence is effected by way of spray coating. In some embodiments, for example, the substrate is in the form of a plurality of spaced-apart longitudinally extending bars, extending from a sidewall of the second compartment. In some embodiments, for example, exemplary substrate materials include copper, aluminum, stainless steel.

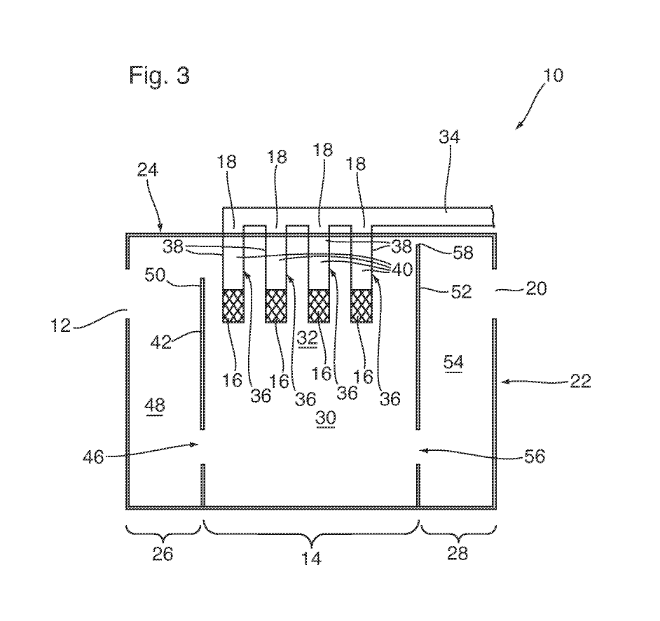

Referring to FIGS. 3 to 5, in some embodiments, for example, the solid catalyst material support 16 includes a permeable container 80 that is configured to contain solid catalyst particulate material and that is permeable to at least the organic liquid material. In some embodiments, for example, the permeable container is in the form of a wire mesh in a cylindrical shape. Such solid catalyst material support may be coupled to the container 22 or the lid 24. An embodiment where such solid catalyst material support 16 is coupled to the lid 24 is further discussed below.

In some embodiments, for example, suitable solid catalyst materials for use in a process that is implemented within the apparatus includes at least one metal. Suitable exemplary metals include iron, manganese, and copper. In some embodiments, for example, the catalyst material includes one or more metal oxides. Suitable metal oxides include iron oxides, copper oxides, and cobalt oxides. In some embodiments, for example, the catalyst material includes a mixed metal oxide, and the mixed metal oxide includes one or more copper oxides and one or more cobalt oxides. In some embodiments, for example, the catalyst material includes a catalyst material supplied by Hydrogen Link Inc., of Saint-Laurent, Quebec, Canada, and having a Commodity Code 3815.90.00.00.

The at least one reagent supply inlet 18 is configured for supplying reagent material to the reaction zone 32 such that contacting of the reagent material and the separated organic material within the reaction zone effects a reactive process, catalyzed by the solid catalyst material, such that a reaction product is produced.

In some embodiments, for example, the lid 24 includes the at least one reagent supply inlet 18. In this respect, the lid 24 is positionable relative to the container 22, such that, when the lid 24 is occluding at least a fraction of the treatment compartment space 30, the at least one reagent supply inlet 18 is disposed for supplying reagent within the treatment compartment space 30. In some embodiments, for example, the lid 24 further includes a reagent distribution manifold 34, and the at least one reagent supply inlet 18 is a plurality of reagent supply inlets 18, and each one of the reagent supply inlets 18 is, independently, fluidly coupled to the reagent distribution manifold 34 for receiving reagent supplied by the reagent distribution manifold 34. In some embodiments, for example, for each one of the at least one reagent supply inlet 18, fluid coupling to the reagent distribution manifold 34 is effected by fluid passages defined within the lid 24.

Referring to FIG. 2, in some embodiments, for example, the at least one reagent supply inlet 18 is defined in one or more perforated tubes, fluidly coupled to the manifold 34. In some of these embodiments, for example, the tubes are mounted to the underside of the lid 24. In some of these embodiments, for example, for each one of the at least one reagent supply inlet 18, independently, the reagent supply inlet 18 is co-operatively disposed with a respective solid catalyst material support 16 such that, when solid catalyst material is supported by the at least one solid catalyst material support 16, the reagent supply inlet 18 is disposed above and in alignment with the solid catalyst material.

Referring to FIGS. 3 to 5, in some embodiments, for example, each one of the at least one reagent supply inlets 18 is defined as apertures disposed within the reagent distribution manifold 34. Each one of the at least one reagent supply inlets 18, independently, is fluidly coupled to a respective reagent delivery apparatus 36, thereby effecting fluid coupling between the reagent distribution manifold 34 and the reagent delivery apparatuses 36. In some embodiments, for example, the reagent delivery apparatus 36 includes a conduit 38 that extends from the corresponding reagent supply inlet 18 to a respective solid catalyst material support 16. The conduit 38 a reagent delivery fluid passage 40 co-operatively disposed with the respective solid catalyst material support 16 such that, when solid catalyst material is supported by the at least one solid catalyst material support, the reagent delivery fluid passage 40 is disposed in alignment with the solid catalyst material. In some embodiments, for example, each one of the at least solid catalyst material support 16, independently, includes a permeable container 80 that is configured to contain solid catalyst particulate material and that is permeable to at least the organic liquid material. In some embodiments, for example, the permeable container 80 is in the form of a wire mesh in a cylindrical shape.

In some embodiments, for example, suitable reagent material for use in a process that is implemented within the apparatus includes an oxidant. Suitable exemplary oxidants include hydrogen peroxide and ozone.

The outlet 20 is for discharging the organic liquid material-depleted liquid phase from the apparatus 10.

In some embodiments, for example, the apparatus 10 further includes a fluid conductor 42. The fluid conductor 42 functions to conduct at least a fraction of the flow of the aqueous liquid mixture, received by the liquid mixture inlet 12, for introduction into the treatment compartment space 30 at a position sufficiently below that of the at least one solid catalyst material support 16. Such position is sufficiently below that of the at least one solid catalyst material support 16 such that, when the aqueous liquid mixture is received within the treatment compartment space 30, the separation of at least a fraction of the organic liquid material from the aqueous liquid mixture is with effect that that disposition of the organic liquid material-enriched liquid phase within the reaction zone 32 is effected. In some embodiments, such position is below the at least one solid catalyst support 16 by a vertical distance of at least ten (10) centimetres, such as, for example, at least 20 centimetres, such as, for example, at least 30 centimetres.

In some embodiments, for example, the fluid conductor 42 includes an upstream baffle 44. In some embodiments, for example, the upstream baffle 42 is disposed between the liquid mixture inlet 12 and the treatment compartment space 30 and functions to interfere with conducting of the supplied aqueous liquid mixture flow from the liquid mixture inlet 12 to the reaction zone 32, while encouraging conducting of the received liquid mixture flow, in a downwardly direction, through a first fluid passage 46, from the inlet 12 to the treatment compartment space 30, and thereby promote the above-described separation such that the organic liquid material-enriched liquid phase becomes disposed within the reaction zone 32.

In some embodiments, for example, the upstream baffle 44 defines an inlet compartment 26 interposed between the liquid mixture inlet 12 and the treatment compartment 14. The inlet compartment 26 includes an inlet compartment space 48. Fluid communication between the inlet compartment space 48 and the treatment compartment space 30 is defined by at least the first fluid passage 46 disposed below the at least one solid catalyst material support 16. In some embodiments, for example, the inlet compartment space 48 and the treatment compartment space 30 are fluidly coupled to one another exclusively through the first fluid passage 46. In some embodiments, for example, the first fluid passage 46 is disposed below the at least one solid catalyst material support 16 by a vertical distance of at least ten (10) centimetres, such as, for example, at least 20 centimetres, such as, for example, at least 30 centimetres. In some embodiments, for example, the first fluid passage 46 extends below the first baffle 44. In some embodiments, for example, the upstream baffle 44, or the upstream battle portion above the first fluid passage 46 (such as, for example, when the first fluid passage 46 penetrates through the upstream baffle 44), defines a continuous, uninterrupted surface. In some embodiments, for example, the upstream baffle 44 includes an uppermost edge 50 co-operatively positioned within the treatment apparatus 10 such that, when solid catalyst material is supported by the at least one solid catalyst material support 16, the uppermost edge 50 is disposed above the solid catalyst material. If the uppermost edge 50 is disposed below the solid catalyst material, there is a risk that the solid catalyst material may not be submerged within the organic liquid material-enriched liquid phase.

In some embodiments, for example, the apparatus 10 further includes a downstream baffle 52 disposed between the treatment compartment space 30 and the outlet 20 for interfering with conduction of at least the reaction products from the treatment compartment space 30 to the outlet 20. In this respect, the downstream baffle 52 interferes with conduction of at least the reaction products, and, in some embodiments, the organic liquid material of the organic liquid material-enriched liquid phase, and thereby mitigates entrainment of the reaction products and/or the organic liquid material within the organic liquid material-depleted phase that is being discharged via the outlet 20.

In some embodiments, for example, the downstream baffle 52 is disposed between the treatment compartment space 30 and the outlet 18 and defines the outlet compartment 28. The outlet compartment 28 includes an outlet compartment space 54 interposed between the treatment compartment space 30 and the outlet 20. The fluid communication between the treatment compartment space 30 and the outlet compartment space 54 is defined by at least a second fluid passage 56 disposed below the at least one solid catalyst material support 16. In some embodiments, for example, the second fluid passage 56 extends below the downstream baffle 54. In some embodiments, for example, the second fluid passage 56 is disposed below the at least one solid catalyst material support 16 by a vertical distance of at least ten (10) centimetres, such as, for example, at least 20 centimetres, such as, for example, at least 30 centimetres.

In some embodiments, for example, the downstream baffle 52, or downstream baffle portion above the second fluid passage 56, defines a continuous, uninterrupted surface. In some embodiments, for example, the treatment compartment space 30 and the outlet compartment space 54 are fluidly coupled to one another exclusively through the second fluid passage 56. In some embodiments, for example, the downstream baffle 52 includes an uppermost edge 58 co-operatively positioned within the treatment apparatus 10 such that, when solid catalyst material is supported by the at least one solid catalyst material support 16, the uppermost edge 58 is disposed above the solid catalyst material. In some embodiments, for example, the uppermost edge is disposed above the solid catalyst material.

In some embodiments, for example, the outlet 20 is disposed above the second fluid passage 56. This mitigates entrainment of solid material, that may have settled to the bottom of the container 10, within the material that is discharging through the outlet 20.

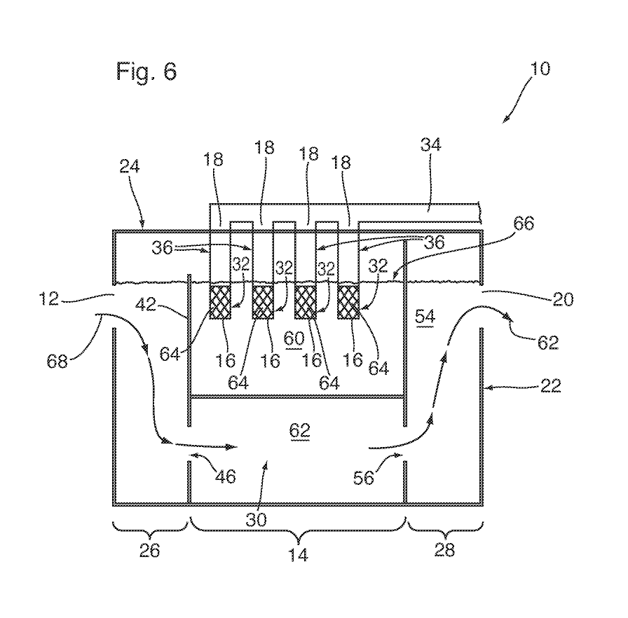

Referring to FIG. 6, there is also provided a process for effecting treatment of the aqueous liquid material.

The process includes effecting separation, based on density differences, from the aqueous liquid mixture, of at least a fraction of organic liquid material of the aqueous liquid material such that an organic liquid material-enriched phase 60 becomes disposed above an organic liquid material-depleted phase 62. The density of the organic liquid material is less than the density of water. As a result, the organic liquid material has a tendency to separate from the organic liquid material and become disposed above the organic liquid material-depleted phase. In this respect, in some embodiments, for example, the separation is effected in response to buoyancy forces. After the separation is effected, the organic liquid material-enriched phase is contacted with the reagent material within the reaction zone 32 and in sufficient proximity to solid catalyst material 64 such that the reactive process, effected by the contacting, and catalyzed by the solid catalyst material, effects production of the reaction products. Periodically, the reaction products and, in some embodiments, for example, unreacted organic liquid material of the organic liquid material-enriched liquid phase, may be recovered. In some embodiments, for example, the process is implemented within any one of the embodiments of the apparatus 10.

The reactive process effects conversion of the organic liquid material of the organic liquid material-enriched liquid phase to the reaction products. The total volume of the produced reaction products is less than the total volume of the organic liquid material that is converted by the reactive process. In some embodiments, for example, the total volume of the produced reaction products is less than 75% of the total volume of the organic material-enriched liquid phase that is converted by the reactive process. In some embodiments, for example, the total volume of the produced reaction products is less than 50% of the total volume of the organic material-enriched liquid phase that is converted by the reactive process. In some embodiments, for example, the total volume of the produced reaction products is less than 25% of the total volume of the organic material-enriched liquid phase that is converted by the reactive process. In some embodiments, for example, the reactive process effects evolution of gaseous material, such as, for example, gaseous carbon dioxide). In effect, the reactive process effects a reduction in the total volume of organic matter that is recoverable, thereby reducing the frequency at which such organic matter (the reaction products and any residual organic liquid material-enriched liquid phase) needs to be recovered from the apparatus.

In some embodiments, for example, both of the effecting separation and the contacting are effected within a treatment compartment space 30 of the container 22. In some embodiments, for example, the process further includes, prior to the effecting separation, supplying the aqueous liquid material 68 to the treatment compartment space 30 via the liquid mixture inlet 12 of the container 22. In some embodiments, for example, the process further includes, after the effecting separation, recovering the organic liquid material-depleted phase via the outlet 20 of the container 22. In some embodiments, for example, the recovering of the organic liquid material-depleted phase is effected in response to a fluid pressure differential applied between the inlet 12 and the outlet 20 of the container 22. In some embodiments, for example, the applied fluid pressure differential effects the supplying of the aqueous liquid material via the inlet 12.

In some embodiments, for example, the process further includes, after the effecting separation, periodically skimming the surface 66 of the liquid within the treatment compartment space 30 for effecting recovery of at least the reaction products.

In some embodiments, for example, the recovering via the outlet 20 is effected while the aqueous liquid mixture is being supplied via the inlet 12.

In the above description, for purposes of explanation, numerous details are set forth in order to provide a thorough understanding of the present disclosure. However, it will be apparent to one skilled in the art that these specific details are not required in order to practice the present disclosure. Although certain dimensions and materials are described for implementing the disclosed example embodiments, other suitable dimensions and/or materials may be used within the scope of this disclosure. All such modifications and variations, including all suitable current and future changes in technology, are believed to be within the sphere and scope of the present disclosure. All references mentioned are hereby incorporated by reference in their entirety.

1. A liquid material treatment apparatus comprising:
an inlet for receiving flow of an aqueous liquid mixture including water and an organic liquid material;
a treatment compartment including a treatment compartment space disposed in fluid communication with the inlet for receiving the aqueous liquid mixture, the treatment compartment space being configured such that, when the aqueous liquid mixture is received by the treatment compartment space, separation of at least a fraction of the organic liquid material from the aqueous liquid mixture, based on differences in density, is effected within the treatment compartment space such that an organic liquid material-enriched liquid phase becomes disposed above an organic liquid material-depleted liquid phase within the treatment compartment space;
at least one solid catalyst material support, wherein each one of the at least one solid catalyst material support is, independently, configured for supporting solid catalyst material within a reaction zone of the treatment compartment space;
at least one reagent supply inlet configured for supplying reagent material to the reaction zone such that contacting of the reagent material and the separated organic material within the reaction zone effects a reactive process, catalyzed by the solid catalyst material, such that a reaction product is produced; and
an outlet for discharging the organic liquid material-depleted liquid phase from the apparatus.

2. The liquid material treatment apparatus as claimed in claim 1, further comprising:
a fluid conductor for conducting at least a fraction of the flow of the aqueous liquid mixture, received by the inlet, for introduction into the treatment compartment space at a position sufficiently below that of the at least one solid catalyst material support such that, when the aqueous liquid mixture is received within the treatment compartment space, the separation of at least a fraction of the organic liquid material from the aqueous liquid mixture is such that disposition of the organic liquid material-enriched liquid phase within the reaction zone is effected.

3. The liquid material treatment apparatus as claimed in claim 3;
wherein the fluid conductor extends sufficiently below the at least one solid catalyst material support such that the introduction of the aqueous liquid mixture into the treatment compartment space is at a position disposed below the at least one solid catalyst material support.

4. The liquid material treatment apparatus as claimed in claim 2;
wherein the fluid conductor includes an upstream baffle.

5. The liquid material treatment apparatus as claimed in claim 4;
wherein the upstream baffle is disposed between the liquid mixture inlet and the treatment compartment space and defines an inlet compartment space interposed between the liquid mixture inlet and the treatment compartment space;
and wherein fluid communication between the inlet compartment space and the treatment compartment space is defined by at least a first fluid passage disposed below the at least one solid catalyst material support.

6. The liquid material treatment apparatus as claimed in claim 5;
wherein the inlet compartment space and the treatment compartment space are fluidly coupled to one another exclusively through the first fluid passage.

7. The liquid material treatment apparatus as claimed in claim 5 or 6;
wherein the first fluid passage extends below the upstream baffle.

8. The liquid material treatment apparatus as claimed in any one of claims 5 to 7;
wherein the first fluid passage is disposed below the at least one solid catalyst material support.

9. The liquid material treatment apparatus as claimed in any one of claims 4 to 8;
wherein the upstream baffle includes an uppermost edge co-operatively positioned within the liquid treatment apparatus such that, when solid catalyst material is supported by the at least one solid catalyst material support, the uppermost edge is disposed above the solid catalyst material.

10. The liquid material treatment apparatus as claimed in any one of claims 4 to 9;
wherein the upstream baffle, or upstream baffle portion above the first fluid passage, defines a continuous, uninterrupted surface.

11. The liquid material treatment apparatus as claimed in any one of claims 1 to 10 further comprising:
a downstream baffle disposed between the treatment compartment and the outlet for interfering with conduction of at least the reaction products from the treatment compartment space to the outlet.

12. The liquid material treatment apparatus as claimed in claim 11;
wherein the downstream baffle is disposed between the treatment compartment space and the outlet and defines an outlet compartment interposed between the treatment compartment space and the outlet;
and wherein fluid communication between the treatment compartment space and the outlet compartment is defined by at least a second fluid passage disposed below the at least one solid catalyst material support.

13. The liquid material treatment apparatus as claimed in claim 12;
wherein the treatment compartment space and the outlet compartment are fluidly coupled to one another exclusively through the second fluid passage.

14. The liquid material treatment apparatus as claimed in claim 12 or 13;
wherein the second fluid passage extends below the downstream baffle.

15. The liquid material treatment apparatus as claimed in any one of claims 12 to 14;
wherein the second fluid passage is disposed below the at least one solid catalyst material.

16. The liquid material treatment apparatus as claimed in any one of claims 11 to 15;
wherein the downstream baffle includes an uppermost edge co-operatively positioned within the liquid treatment apparatus such that, when solid catalyst material is supported by the at least one solid catalyst material support, the uppermost edge is disposed above the solid catalyst material.

17. The liquid material treatment apparatus as claimed in any one of claims 11 to 16;
wherein the downstream baffle, or downstream baffle portion above the second fluid passage, defines a continuous, uninterrupted surface.

18. The liquid material treatment apparatus as claimed in any one of claims 1 to 17, further comprising:
a container defining at least the treatment compartment; and
a lid, including the at least one reagent supply inlet, and positionable relative to the container, such that, when the lid is occluding at least a fraction of the treatment compartment space, the at least one reagent supply inlet is disposed for supplying reagent within the treatment compartment space.

19. The liquid material treatment apparatus as claimed in claim 18;
wherein the lid further includes a reagent distribution manifold;
and wherein the at least one reagent supply inlet is a plurality of reagent supply inlets, and each one of the reagent supply inlets is, independently, fluidly coupled to the reagent distribution manifold for receiving reagent supplied by the reagent distribution manifold.

20. The liquid material treatment apparatus as claimed in claim 19;
wherein, for each one of the reagent supply inlet, fluid coupling to the reagent distribution manifold is effected by fluid passages defined within the lid.

21. The liquid material treatment apparatus as claimed in any one of claims 18 to 20;
wherein each one of the at least one reagent supply inlets, independently, is fluidly coupled to a respective reagent delivery apparatus, wherein the reagent delivery apparatus includes a conduit, the conduit extending from the corresponding reagent supply inlet to a respective solid catalyst material support and including a reagent delivery fluid passage co-operatively disposed with the respective solid catalyst material support such that, when solid catalyst material is supported by the at least one solid catalyst material support, the reagent delivery fluid passage is disposed in alignment with the solid catalyst material.

22. The liquid material treatment apparatus as claimed in any one of claims 1 to 21;
wherein each one of the at least solid catalyst material support, independently, includes a permeable container that is configured to contain solid catalyst particulate material and that is permeable to at least the organic liquid material.

23. A process for treating an aqueous liquid mixture comprising:
effecting separation, based on density differences, from an aqueous liquid mixture, of at least a fraction of organic liquid material of the aqueous liquid material such that an organic liquid material-enriched phase becomes disposed above an organic liquid material-depleted phase; and
contacting the organic liquid material-enriched phase with reagent material within a reaction zone and in sufficient proximity to a solid catalyst material such that a reactive process, effected by the contacting, and catalyzed by the solid catalyst material, effects production of reaction products.

24. The process as claimed in claim 23;
wherein both of the effecting separation and the contacting are effected within a treatment space of a container.

25. The process as claimed in claim 24, further comprising:
prior to the effecting separation, supplying the aqueous liquid material to the treatment space via an inlet of the container;

26. The process as claimed in claim 24 or 25, further comprising;
after the effecting separation, recovering the organic liquid material-depleted via an outlet of the container.

27. The process as claimed in claim 26;
wherein the recovering of the organic liquid material-depleted phase is effected in response to a fluid pressure differential applied between the inlet and the outlet of the container.

28. The process as claimed in claim 27;
wherein the applied fluid pressure differential effects the supplying of the aqueous liquid material via the inlet.

29. The process as claimed in any one of claims 26 to 28;
wherein the recovering via the outlet is effected while the aqueous liquid mixture is being supplied via the inlet.

30. The process as claimed in any one of claims 23 to 29, further comprising:
after the effecting separation, periodically skimming the surface of the liquid within the treatment space for effecting recovery of at least the reaction products.

31. The process as claimed in any one of claims 23 to 30;
wherein the reactive process effects conversion of the organic liquid material of the organic liquid material-enriched liquid phase to reaction products;
and wherein the total volume of the produced reaction products is less than the total volume of the organic liquid material that is converted by the reactive process.

32. The process as claimed in claim 31;
wherein the total volume of the produced reaction products is less than 75% of the total volume of the organic liquid material that is converted by the reactive process.

33. The process as claimed in claim 31;
wherein the total volume of the produced reaction products is less than 50% of the total volume of the organic liquid material that is converted by the reactive process.

34. The process as claimed in claim 31;
wherein the total volume of the produced reaction products is less than 25% of the total volume of the organic liquid material that is converted by the reactive process.

35. The process as claimed in any one of claims 24 to 34;
wherein the organic liquid material of the aqueous liquid mixture includes at least one of fats, oils, and greases.
